(19) United States
(12) Patent Application Publication
(10) Pub. No.: US 2026/0111708 A1
(43) Pub. Date: Apr. 23, 2026

(54) MANAGEMENT OF LONG-TERM MEMORY RECALL FOR A LARGE LANGUAGE MODEL THROUGH A SELF-REFLECTION PROTOCOL

(71) Applicant: Robert Bosch GmbH, Stuttgart (DE)

(72) Inventors: Jiajing GUO, Mountain View, CA (US); Vikram MOHANTY, Arlington, VA (US); Jorge Henrique PIAZENTIN ONO, Sunnyvale, CA (US); Wenbin HE, Sunnyvale, CA (US); Liu REN, Saratoga, CA (US)

(21) Appl. No.: 18/924,628

(22) Filed: Oct. 23, 2024

(51) Int. Cl. G06N 3/0455

(52) U.S. Cl. CPC G06N 3/0455

(57) ABSTRACT

Methods for developing and managing long-term memory solutions for large language models (LLMs) within a context of providing agents of the LLM as a service are disclosed. Following task-related communications between LLM agents and users of the service, information pertaining to domain knowledge, user preferences, and success or not in completing the requested task is distilled into data samples by a reflections agent of the service. The data samples are then stored into a long-term memory database that is accessible by LLM agents in the future, such that the agents can recall information of previous interactions in order to more efficiently perform new tasks for users.

### TECHNICAL FIELD

The present disclosure relates to the enabling long-term memory solutions for large language models.

### BACKGROUND

Large language models (LLMs) have demonstrated strong performance on a wide variety of tasks, leading to their increased involvement in larger systems. For instance, they are often used to provide supervision or as tools in decision-making processes. Large, open-source datasets that are applied as training datasets for LLMs allow for LLMs to be applicable in generalized tasks. However, previous implementations of LLMs in specific corporate environments where further and unique context is needed have yet to be successful. Furthermore, the previous implementations often require white-box access to these models, in which weights, hidden states, or other internal parameters are analyzed and subsequently adjusted.

### SUMMARY

The present disclosure relates to developing and managing a long-term memory database for an LLM service, in which LLM agents of the service can access the database and apply previously learned knowledge to new tasks that are related or somehow similar. Communications logs between users and LLM agents are analyzed by a reflections agent, which performs a reflections protocol to distill information within the messages between the users and LLM agents into compact data samples that are then stored into a long-term memory database. Then, at a later moment in time, an LLM agent may recall some of those data samples in order to more efficiently perform a new task for a user, rather than having to be prompted again with certain domain knowledge or user preferences again. The long-term memory database further allows the LLM service to act as a shared knowledge base within a corporate setting.

### BRIEF DESCRIPTION OF THE DRAWINGS

FIG. 1 illustrates a system for training and utilizing a machine learning model, such as a large language model, according to some embodiments.

FIG. 2 illustrates a computer-implemented method for training and utilizing a machine learning model, such as a large language model, according to some embodiments.

FIG. 3 illustrates a service provider network that is configured to implement an LLM service and manage the long-term memory storage of the LLM, according to some embodiments.

FIG. 4 is a flow diagram that illustrates a process of performing tasks for users of the LLM service and subsequently performing a reflections protocol to enable the LLM service to store those results into a long-term memory database, and then recall results of performing those tasks during performance of future tasks, according to some embodiments.

FIG. 5 is a flow diagram that illustrates a first sub-process of performing the reflections protocol introduced in FIG. 4 pertaining to domain knowledge categories, according to some embodiments.

FIG. 6 is a flow diagram that illustrates a second sub-process of performing the reflections protocol introduced in FIG. 4 pertaining to user preferences, according to some embodiments.

FIG. 7 is a flow diagram that illustrates a third sub-process of performing the reflections protocol introduced in FIG. 4 pertaining to success of the LLM agent in performing the task, according to some embodiments.

FIG. 8 is a flow diagram that illustrates a fourth sub-process of performing the reflections protocol introduced in FIG. 4 pertaining to failure of the LLM agent in performing the task, according to some embodiments.

FIG. 9A illustrates an example of a user interface in which a user of the LLM service may chat with an LLM agent of the service in order to perform a task, according to some embodiments.

FIG. 9B illustrates another portion of the user interface in which data samples that were generated during the reflections protocol may be provided for viewing and editing by a user of the LLM service, according to some embodiments.

FIG. 9C illustrates an example in which the user may add, via the user interface, additional data samples to those that were generated during the reflections protocol, according to some embodiments.

FIG. 10A illustrates another portion of the user interface in which a user of the LLM service may view and search for data samples which have already been stored to the long-term memory database, according to some embodiments.

FIG. 10B illustrates an example of a data sample from long-term memory storage that is being viewed by a user using the user interface, according to some embodiments.

FIG. 10C illustrates another example of a data sample from long-term memory storage that is being viewed by a user using the user interface, according to some embodiments.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

LLMs have demonstrated remarkable potential in text generation and reasoning, which has thus been extended into applications of LLMs into decision-making instances and tool usage. As such, corporations, companies, and other enterprises have shown interest in incorporating LLM agents into performance of day-to-day tasks in order to enhance employee productivity and to streamline processes in the workplace. However, previous implementations of LLMs into the workplace have had limited results, since the LLMs have been trained on generalized training datasets but therefore lack company-specific knowledge, context, or other internal procedures that cannot be otherwise learned from generalized, open-source training datasets.

Thus, attempts have been made to inject domain knowledge and skillsets into the training of LLMs in order to implement them into various workplace settings. Previous implementations have attempted to create a more robust “memory” for the LLM, specifically through supervised reflection generation and through unsupervised reflection generation. However, these previous implementations either require enormous amounts of training data, or create inconsistencies due to unsupervised reflection generations which are not monitored or validated prior to implementation of the model into the workplace.

In order to address these challenges, the present disclosure develops and manages a long-term memory of the LLM such that LLM agents can “recall” information that the model has learned over time and also edit or otherwise update reflections that change over time as the company evolves. When users chat with LLM agents, the messages within the conversation are provided to a reflections agent, which then performs a reflections protocol using the communications log. The reflections protocol is used to generate data samples from the conversation that relate to different domain knowledge categories, to user preferences that may then be used to build individual user profiles of employees within the company, and to success or failure of the LLM agent in completing various tasks for users. Those data samples are then stored into a long-term memory database such that, at a later moment in time when the LLM agent is performing a related task, the data samples can be referenced. This prevents the user from having to re-explain company-specific procedures, preferences, or other protocols each time to the LLM agent, and enables the LLM to develop a long-term memory that is specific to the implementation of the LLM into the specific workplace environment.

The following description continues with a general introduction to machine learning techniques that are relevant to the methods for developing and managing a long-term memory database for LLMs described herein. Next, various embodiments pertaining to the architecture and processes that enable such long-term memory for recall by the LLM are discussed. The present disclosure then demonstrates the versatility of the methods and systems described herein by illustrating various applied embodiments of said methods and systems.

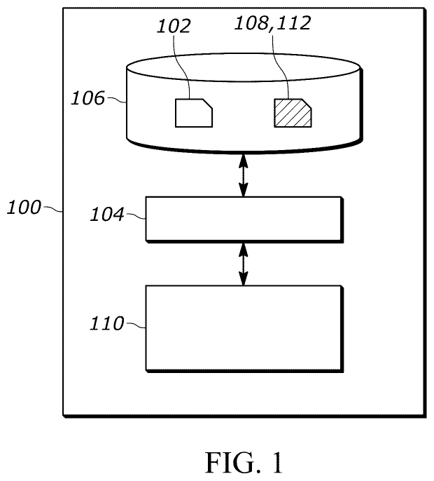

FIG. 1 illustrates a system 100 for utilizing a large language model (LLM). An LLM may describe a machine learning model that is configured to learn complex patterns and representations based on training and/or validation datasets that are used as inputs to the LLM. With regard to the present disclosure, an LLM additionally refers to an LLM that has been at least partially trained using one or more training datasets. For example, open-sourced datasets may have previously been applied as training datasets such that the LLM has learned a general knowledge about interacting with people, such as in chat-based interactions. However, the LLM lacks specific knowledge pertaining to company-specific information, preferences of employees at the company, etc.

Additional embodiments pertaining to LLMs and agents are described herein with regard to LLM agents 310, 312, and 314, reflections agent 316, and blocks 404, 406, 410, 412, 502-508, 602-608, 702-708, and 802-808.

In order to further illustrate various states of untrained and trained versions of the LLM, the following paragraphs detail a process of training the LLM, and refer depictions shown in FIG. 1.

In some embodiments, the system 100 may comprise an input interface for accessing training data 102 for the LLM. For example, as illustrated in FIG. 1, the input interface may be constituted by a data storage interface 104 which may access the training data 102 from a data storage 106. For example, the data storage interface 104 may be a memory interface or a persistent storage interface, e.g., a hard disk or an SSD interface, but also a personal, local or wide area network interface such as a Bluetooth, ZigBee or Wi-Fi interface or an Ethernet or fiber optic interface. The data storage 106 may be an internal data storage of the system 100, such as a hard drive or SSD, but also an external data storage, e.g., a network-accessible data storage.

In some embodiments, the data storage 106 may further comprise a data representation 108 of an untrained version of the model (e.g., a version of the machine learning model that has yet to be trained) which may be accessed by the system 100 from the data storage 106. It will be appreciated, however, that the training data 102 and the data representation 108 of the untrained LLM may also each be accessed from a different data storage, e.g., via a different subsystem of the data storage interface 104. Each subsystem may be of a type as is described above for the data storage interface 104. In other embodiments, the data representation 108 of the untrained LLM may be internally generated by the system 100 on the basis of design parameters for the LLM, and therefore may not explicitly be stored on the data storage 106. The system 100 may further comprise a processor subsystem 110 which may be configured to, during operation of the system 100, provide an iterative function as a substitute for a stack of layers of the LLM to be trained. Here, respective layers of the stack of layers being substituted may have mutually shared weights and may receive, as input, an output of a previous layer, or for a first layer of the stack of layers, an initial activation, and a part of the input of the stack of layers. The processor subsystem 110 may be further configured to iteratively train the LLM using the training data 102 (e.g., thus generating updated versions of the machine learning model with respect to a first “untrained” version of the model). Here, an iteration of the training by the processor subsystem 110 may comprise a forward propagation part and a backward propagation part. The processor subsystem 110 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the LLM.

The system 100 may further comprise an output interface for outputting a data representation 112 of the trained LLM, this data may also be referred to as trained model data 112. For example, as also illustrated in FIG. 1, the output interface may be constituted by the data storage interface 104, with said interface being in these embodiments an input/output (“IO”) interface, via which the trained model data 112 may be stored in the data storage 106. For example, the data representation 108 defining the ‘untrained’ LLM may during or after the training be replaced, at least in part by the data representation 112 of the trained LLM, in that the parameters of the LLM, such as weights, hyperparameters, and other types of parameters of the LLM, may be adapted to reflect the training on the training data 102. This is also illustrated in FIG. 1 by the reference numerals 108 and 112 referring to the same data record on the data storage 106. In other embodiments, the data representation 112 may be stored separately from the data representation 108 defining the ‘untrained’ LLM. In some embodiments, the output interface may be separate from the data storage interface 104, but may in general be of a type as described above for the data storage interface 104.

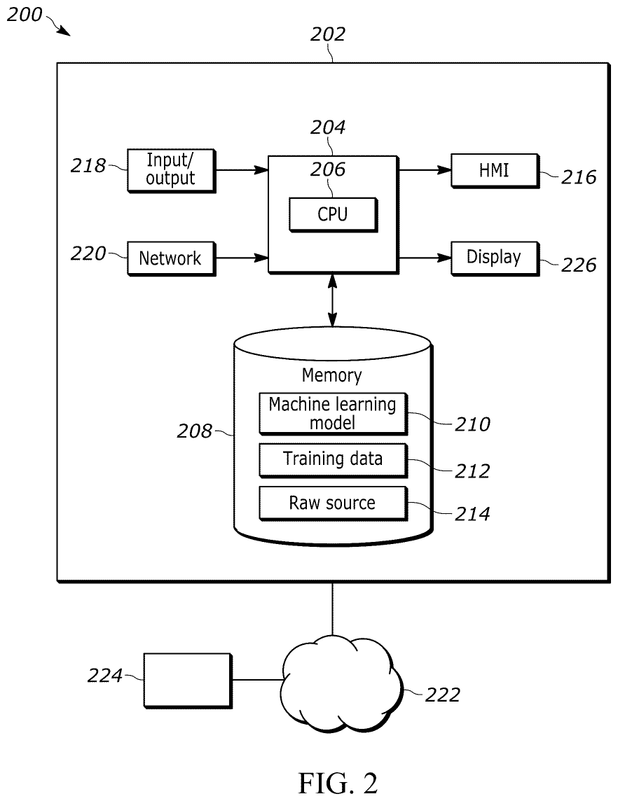

FIG. 2 illustrates a computer-implemented method for training and utilizing an LLM, according to some embodiments. The system 200 may include at least one computing system 202. The computing system 202 may include at least one processor 204 that is operatively connected to a memory unit 208. The processor 204 may include one or more integrated circuits that implement the functionality of a central processing unit (CPU) 206 and, in some embodiments, a graphics processing unit (GPU). The CPU 206 may be a commercially available processing unit that implements an instruction set such as one of the x86, ARM, Power, or MIPS instruction set families. During operation, the CPU 206 may execute stored program instructions that are retrieved from the memory unit 208. The stored program instructions may include software that controls operation of the CPU 206 to perform the operation described herein. In some examples, the processor 204 may be a system on a chip (SoC) that integrates functionality of the CPU 206, the memory unit 208, a network interface, and input/output interfaces into a single integrated device. The computing system 202 may implement an operating system for managing various aspects of the operation.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine learning model 210 or algorithm, a training and/or fine-tuning dataset 212 for the machine learning model 210, raw source dataset 214, etc.

Non-volatile storage may include one or more persistent data storage devices such as a hard drive, optical drive, tape drive, non-volatile solid-state device, cloud storage or any other device capable of persistently storing information. Processor 204 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory unit 208. Memory 208 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information. Moreover, processor 204 and memory 208 may be configured to provide collected data to one or more other computing devices that are configured to execute the LLM service within various embodiments presented herein.

Processor 204 may be configured to read into memory 208 and execute computer-executable instructions residing in non-volatile storage and embodying one or more machine learning algorithms and/or methodologies of one or more embodiments. Non-volatile storage may include one or more operating systems and applications. Non-volatile storage may store compiled and/or interpreted from computer programs created using a variety of programming languages and/or technologies, including, without limitation, and either alone or in combination, Java, C, C++, C #, Objective C, Fortran, Pascal, Java Script, Python, Perl, and PL/SQL.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

The processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

The computing system 202 may include a network interface device 220 that is configured to provide communication with external systems and devices. For example, the network interface device 220 may include a wired and/or wireless Ethernet interface as defined by Institute of Electrical and Electronics Engineers (IEEE) 802.11 family of standards. The network interface device 220 may include a cellular communication interface for communicating with a cellular network (e.g., 3G, 4G, 5G). The network interface device 220 may be further configured to provide a communication interface to an external network 222 or cloud.

The external network 222 may be referred to as the world-wide web or the Internet. The external network 222 may establish a standard communication protocol between computing devices. The external network 222 may allow information and data to be easily exchanged between computing devices and networks. One or more servers 224 may be in communication with the external network 222.

The computing system 202 may include an input/output (I/O) interface 218 that may be configured to provide digital and/or analog inputs and outputs. The I/O interface 218 may include additional serial interfaces for communicating with external devices (e.g., Universal Serial Bus (USB) interface).

The computing system 202 may include a human-machine interface (HMI) device 216 that may include any device that enables the system 200 to receive control input. Examples of input devices may include human interface inputs such as keyboards, mice, touchscreens, voice input devices, and other similar devices. The computing system 202 may include a display device 226. The computing system 202 may include hardware and software for outputting graphics and text information to the display device 226. The display device 226 may include an electronic display screen, projector, printer or other suitable device for displaying information to a user or operator. The computing system 202 may be further configured to allow interaction with remote HMI and remote display devices via the network interface device 220.

The system 200 may be implemented using one or multiple computing systems. While the example depicts a single computing system 202 that implements all of the described features, it is intended that various features and functions may be separated and implemented by multiple computing units in communication with one another. The particular system architecture selected may depend on a variety of factors.

The system 200 may implement a machine learning algorithm 210 that is configured to analyze the raw source dataset 214. The raw source dataset 214 may include raw or unprocessed sensor data that may be representative of an input dataset for a machine learning system. In some examples, the machine learning algorithm 210 may be an LLM that is designed to perform a predetermined function. For example, the LLM algorithm may be configured within a context of learning company-specific procedures in order to chat with employees of said company, perform tasks for those employees, and otherwise assist those employees in day-to-day corporate settings.

The computer system 200 may store a training dataset 212 for the machine learning algorithm 210. The training dataset 212 may represent a set of previously constructed data for training the machine learning algorithm 210. The training dataset 212 may be used by the machine learning algorithm 210 to learn weighting factors associated with an LLM algorithm. The training dataset 212 may include a set of source data that has corresponding outcomes or results that the machine learning algorithm 210 tries to duplicate via the learning process.

The machine learning algorithm 210 may be operated in a learning mode using the training dataset 212 as input. The machine learning algorithm 210 may be executed over a number of iterations using the data from the training dataset 212. With each iteration, the machine learning algorithm 210 may update internal weighting factors based on the achieved results. For example, the machine learning algorithm 210 can compare output results (e.g., annotations) with those included in the training dataset 212. Since the training dataset 212 includes the expected results, the machine learning algorithm 210 can determine when performance is acceptable. After the machine learning algorithm 210 achieves a predetermined performance level (e.g., 100% agreement with the outcomes associated with the training dataset 212), the machine learning algorithm 210 may be executed using data that is not in the training dataset 212. The trained machine learning algorithm 210 may be applied to new datasets to generate annotated data.

The machine learning algorithm 210 may be configured to identify a particular feature in the raw source data 214. The raw source data 214 may include a plurality of instances or input dataset for which annotation results are desired. The machine learning algorithm 210 may be programmed to process the raw source data 214 to identify the presence of the particular features. The machine learning algorithm 210 may be configured to identify a feature in the raw source data 214 as a predetermined feature. The raw source data 214 may be derived from a variety of sources. For example, the raw source data 214 may be actual input data collected by a machine learning system. The raw source data 214 may be machine generated for testing the system.

In the example, the machine learning algorithm 210 may then process raw source data 214 and output results in order to complete a task for an emplyee. A machine learning algorithm 210 may generate a confidence level or factor for each output generated. For example, a confidence value that exceeds a predetermined high-confidence threshold may indicate that the machine learning algorithm 210 is confident that the identified feature corresponds to the particular feature. A confidence value that is less than a low-confidence threshold may indicate that the machine learning algorithm 210 has some uncertainty that the particular feature is present.

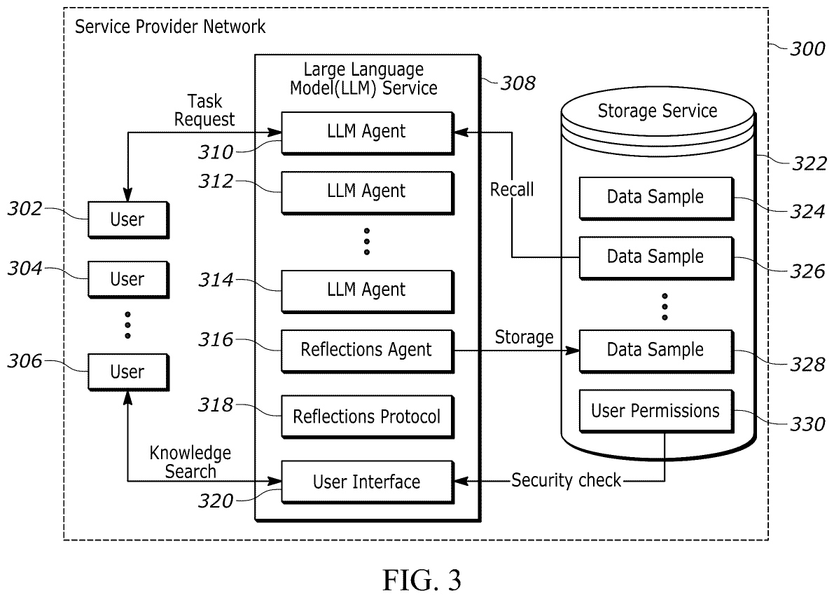

As description for FIGS. 1 and 2 has provided context for training and utilizing LLMs, FIG. 3-10C and the related discussion herein will now focus on developing and managing the long-term memory of such LLMs in order to perform tasks within corporate environments more efficiently. Furthermore, moments in time above that related to training LLMs described changing, updating, or evolving weights and/or other parameters of the model over time as part of a learning process. The discussion hereafter, however, pertains to using reflections agents to analyze communications logs between users of the LLM and various LLM agents. Thus, it should be understood that the development and management of the long-term memory does not pertain to fine-tuning the model itself, which would be referring to further refining, updating, and/or otherwise changing weights and parameters of the LLM during the fine-tuning, and/or re-training process. Development and management of the long-term memory instead pertains to storing data samples of note or importance within a long-term memory database, such that LLM agents may refer to the stored data samples in the future when performing other tasks for employees of the company. This may also be referred to herein as a process of recall.

FIG. 3 illustrates a service provider network that is configured to implement an LLM service and manage the long-term memory of the LLM, according to some embodiments.

As introduced above, the use of the LLM may be provided as a service by a service provider. For example, LLM service 308 may be configured to make an LLM and corresponding agents of the LLM accessible to employees of a company. LLM service 308 may then be configured to enable employees, hereinafter “users,” of the service to chat with agents of the LLM in order to request that certain day-to-day task be completed by LLM agents. As the LLM of LLM service 308 is intended to remain accessible to the company for an extended period of time, it is advantageous for the service to develop and manage a long-term memory of the LLM, such that the LLM may recall useful and relevant conversations that the LLM has previously had with users of the LLM when fulfilling a new task.

As there is certain company-specific protocols, procedures, and/or confidential information that the LLM may be given access to while being executed to perform tasks for users of the service, it is pertinent that the LLM recall data samples pertaining to such protocols, procedures, and confidential information, rather than a user having to re-explain them to the LLM during each subsequent request for the LLM agent to perform a task. However, rather than re-training the model on company-specific preferences or procedures that may not have enough data points to generate a full training dataset or may evolve over time, the service stores data samples that correspond to instances in which the LLM was made aware of the company-specific preferences or procedures into a long-term memory database.

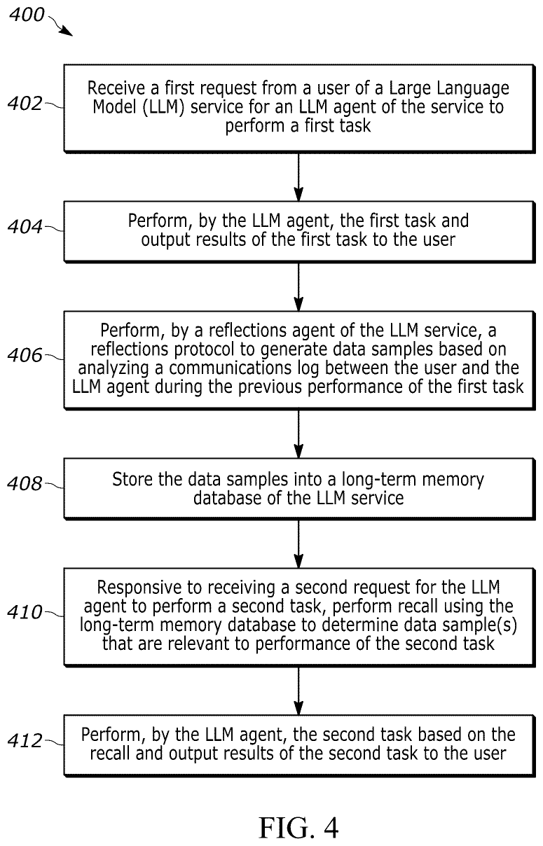

For example, if a user of a company utilizing the LLM service 308 prepares a series of plots each quarter that pertain to sales and costs of the last quarter and are to be provided to investors of the company, the user may request that an LLM agent prepare the series of plots. During a first instance that the user requests these plots, the user may have to specify to the LLM agent that these are to be bar charts, not line graphs, and that the x-axis of these plots should come from column 2 of the dataset they are providing to the LLM agent, not column 3, etc. However, after that conversation with the LLM agent, a reflections agent is configured to perform a reflections protocol based on a communications log between the LLM agent and that user. The reflections protocol is explained in additional detail with regards to FIG. 4-8. However, following the extraction of data samples that pertain to details that (1) a series of plots is to be generated quarterly, (2) that the plots are to be bar charts, and (3) that the x-axis of the plots refer to column 2 of the provided dataset, the LLM agent can recall those data samples during the next request to prepare the series of quarterly plots, and proactively provide bar charts that reflect column 2 as the x-axis, etc. Such a process of recall enables the LLM agent to efficiently and proactively meet needs of the users of the service and also ensures that the LLM agent does not need to be retaught certain company-specific protocols, procedures, and/or confidential information each time the LLM agent chats with a user to perform another task.

Referring now to FIG. 3, an LLM service 308 is configured to allow LLM agents to chat with users while also developing and managing the long-term memory of the LLM service. Users 302, 304, and 306 refers to the computing devices that employees of the company are using to chat with the LLM service 308. As indicated by the ellipses, the LLM service 308 is configured to interact with any number of users. Furthermore, even if users 302, 304, and 306 are located at different physical locations or premises, communications with LLM service 308, such as via a network 222, are secure communications, as indicated by the logical designation of service provider network 300. Moreover, the service provider may be configured to utilize multiple services in order to provide LLM service 308 to users. For example, storage service 322 may resemble a data center, which may be yet another physical location that is different from where computing devices configured to implement LLM service 308 reside. However, and again as indicated by the logical designation of service provider network 300, communications between users, the LLM service, and the storage service are secure communications.

In some embodiments, computing devices that implement the LLM service 308 may include one or more agents of the LLM, such as LLM agents 310, 312, and 314, and reflections agent 316. LLM agents 310, 312, and 314 may each represent user-facing implementations of the LLM, such that multiple users at one time may interact, or “chat,” with the LLM. Reflections agent 316 is yet another implementation of the LLM that is configured to analyze communications between the LLM agents and users when performing the reflections protocol 318. As such, reflections agent 316 may be further configured to provide data samples to storage service 322 such that they may be stored in long-term memory.

As also shown in FIG. 3, LLM service 308 may also include a user interface 320. As additionally discussed below, the user interface 320 may be configured to present various data samples to users of LLM service 308 during a “knowledge search,” and may also be configured to present results of a recent reflections protocol 318 to users for inspection.

As introduced above, storage service 322 is configured to house data samples that have been generated during reflections protocol 318. For example, data samples 324, 326, and 328 may resemble data samples that relate to domain knowledge or user preferences that were learned via analysis of communications logs between LLM agents and users when users requested that the LLM service perform a task. Data samples 324, 326, and 328 are data samples that have been stored in long-term memory, and are accessible by the LLM service during future recalls. Furthermore, data samples 324, 326, and 328 resemble vectors that have been formatted in terms of title, content, and generalized tasks.

In some embodiments, storage service 322 may also store user permissions 330 that may also be accessed by LLM service 308. For example, and as illustrated by the arrow “knowledge search” in FIG. 3, user 306 may request, via user interface 320, that the LLM service 308 display any data samples that pertain to previously generated quarterly plots (continuing with the example above). LLM service 308 may then request access to user permissions 330 in order to first confirm that user 306 has sufficient security clearance to view that information before providing those data samples to the user.

As applied herein, “long-term memory” of LLM-based agents may be defined by the following, in which analogies from a structure of human memory, such as sensory, short-term memory, and long-term memory, may be similarly applied to a structure of the memory of LLM-based agents. For example, an LLM agent's short-term memory refers to information which may be retrieved within a context window, and long-term memory refers to an external database, such as the database of storage service 322, from which LLM agents may retrieve, or “recall” data samples. Over time, as more and more conversation logs between LLM agents and users are analyzed by reflections agents, long-term memory of the LLM service may be generated, developed, and subsequently managed using the database of storage service 322. Thus, in some embodiments, long-term memory may be categorized as “explicit,” or conscious memory that is based on events and facts, and “implicit,” or unconscious memory that is based on audio and sense. Explicit memory may be further categorized as episodic and semantic, in which episodic memory is the memory corresponding to everyday events, while semantic memory refers to general world knowledge that humans would naturally have accumulated throughout their lives, such as ideas, concepts, and facts.

By applying such methods of recall via long-term memory storage, LLM service 308, LLM agents of the service are able to fulfill unique and company-specific tasks more efficiently and effectively than if a simple generically trained LLM were to be used in similar corporate contexts.

As additionally illustrated by arrows “task request,” “recall,” “storage,” “knowledge search,” and security check” in FIG. 3, various components of the system within the border shown by service provider network 300 are configured to interact with one another at various moments in time. These interactions are now further described with regard to FIG. 4-8, and will be referenced throughout the below description.

FIG. 4 is a flow diagram that illustrates a process of performing tasks for users of the LLM service and subsequently performing a reflections protocol to enable the LLM service to store those results into a long-term memory database, and then recall results of performing those tasks during performance of future tasks, according to some embodiments.

Process 400 corresponds to a computer-implemented method that may be executed by computing system, such as by computing system 202, according to some embodiments. In block 402, a user of an LLM service begins chatting, via a user interface, with an LLM agent of the service, and requests that the LLM agent perform a task. For example, the user may provide the LLM agent with a spreadsheet that includes product sales for the last month, wherein the spreadsheet includes columns such as date of sale, price of products that were sold, number of products that were sold, product types that were sold, etc., and includes rows such as individual sales over the course of the last month. The user may then request that the LLM agent sort the spreadsheet by product types that were sold, compute the total sales by respective product types, and subsequently plot the sales. The step shown in block 402 is also illustrated in FIG. 3 by the arrow depicting “task request,” when user 302 begins chatting with LLM agent 310 and requests that LLM agent 310 performs a task for them.

In block 404, and continuing with the above example, the LLM agent then responds to the user and attempts to fulfill the requested task. In some embodiments, the LLM agent may sort, compute, and plot the sales as directed by the user, and then output the results of the requested task to the user via the user interface. In other embodiments, the LLM agent may first prompt the user for more information, such as by asking whether the user wants to receive the plots directly, or the programming code used to compute the sales and plot the sales, etc. As such, a conversation back-and-forth between the user and the LLM agent may be conducted until the task is completed. Moreover, the LLM agent may provide initial results of the requested task and then receive an indication from the user that these were not the results they requested, or that the results are incomplete, or that they prefer a different format of the plots or programming language to be used to generate the plots. In such embodiments, the conversation may then continue between the LLM agent and the user as the LLM agent reattempts to complete the task. Furthermore, the LLM agent will deduce that the task has been completed when the user explicitly says that the task has been completed, when the user leaves the chat interface, etc.

In block 406, the LLM service will make the communications log of the recent task performance by the LLM agent available to the reflections agent of the LLM service. The reflections agent then performs a reflections protocol in order to analyze the communications log for information that should be extracted and used to generate data samples that are to be stored in long-term memory. The reflections protocol is executed such that different types of data samples may be extracted, such as data samples that are labeled as belonging to a certain domain knowledge category, data samples that are labeled as belonging to known user preferences of the user that was involved in the recent chat with the LLM agent, data samples that are labeled as successful completions of tasks by the LLM agent (e.g., a “recipe” for success), and data samples that are labeled as insufficient or failures to complete tasks by the LLM agent (e.g., a “lessons learned” scenario).

Moreover, the generation of the data samples refers to the information from the communications log being converted into vectors.

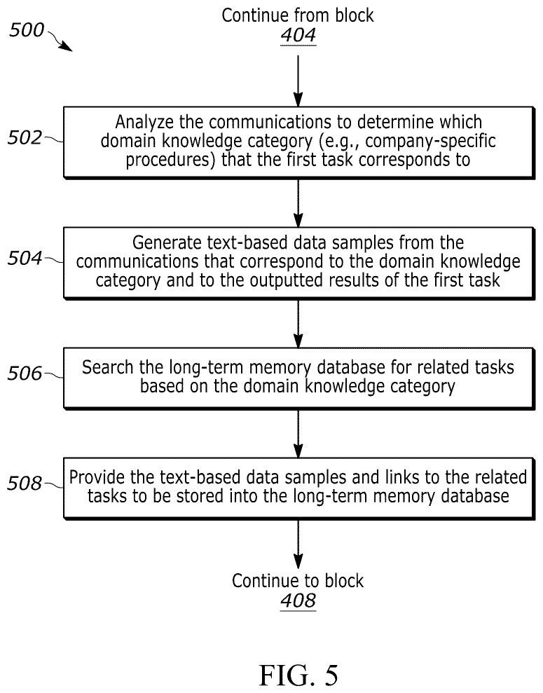

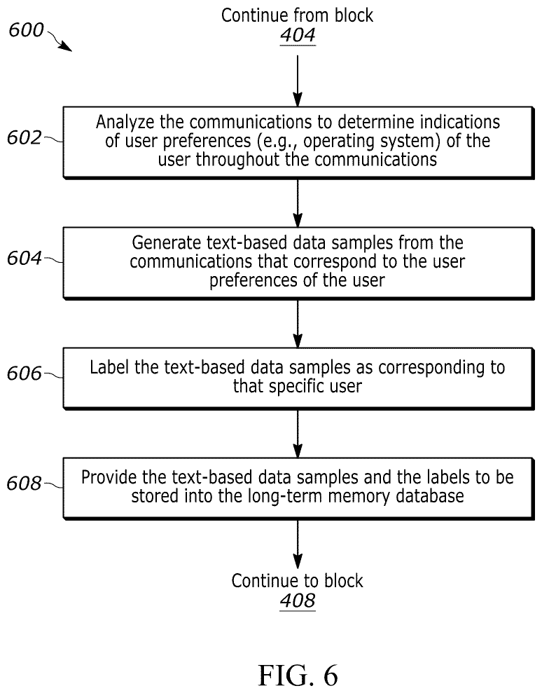

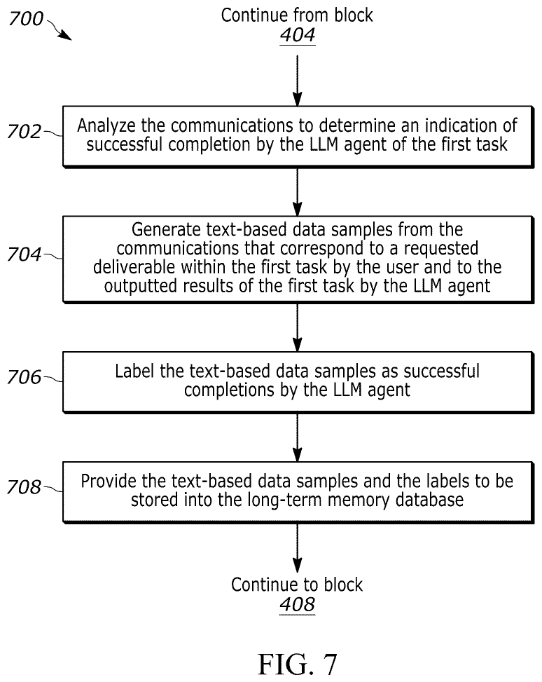

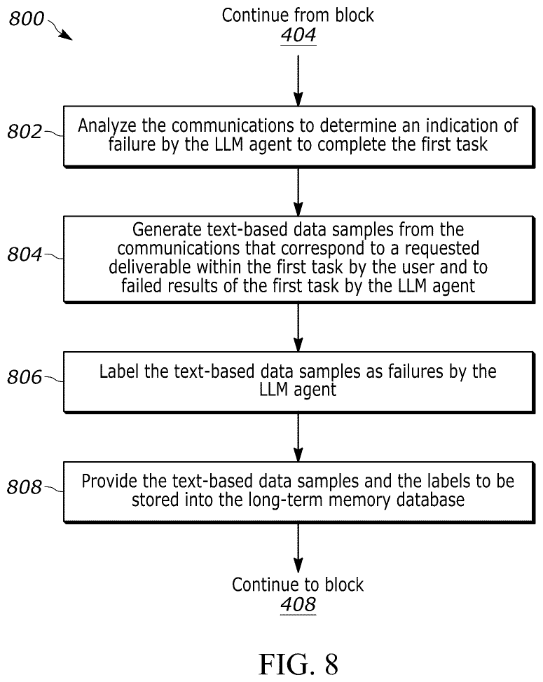

As additionally described below with regard to FIG. 5-8 which illustrate respective portions of the overall process flow for the reflections protocol, the reflections protocol resembles inner monologues that have been applied in prompt engineering in order to improve the LLM agents' reasoning capabilities over time. The process of executing the reflections protocol is configured as an inner monologue framework, wherein the reflections agent answers a series of pre-defined questions, such as “Does this conversation ask the LLM agent to assist with a task?”; “Does the message(s) contain information on a certain topic?”; “What are the information concepts?”; and “Extract the content of each concept now.” Such pre-defined questions may be used by the reflections agent as a “self-reflection” of the LLM service's ability to accurately perform tasks for users of the service, and may be respectfully asked and repeatedly asked in terms of extracting data samples related to domain knowledge categories (see also process 500 in FIG. 5), user preferences (see also process 600 in FIG. 6), successful completions of tasks (see also process 700 in FIG. 7), and failures to complete tasks (see also process 800 in FIG. 8).

Processes 500, 600, 700, and 800 further describe portions of the reflections protocol that is performed by the reflections agent of the LLM service. Returning firstly, however, to the overall process 400 shown in FIG. 4, block 408 indicates a moment in time after which point the reflections agent has extracted useful information or “reflections” from the communications log and has generated corresponding data samples that should be kept accessible for when LLM agents may need to recall that information when performing future tasks. Thus, block 408 illustrates the reflections agent providing the data samples to the storage service for storage into long-term memory. This step is also illustrated in FIG. 3 by the arrow depicting “storage,” when reflections agent 316 provides the generated data sample 328 to be stored into the database within storage service 322.

Moreover, the generated data samples that now resemble vectors are stored into the long-term memory database in a format resembling title, content, and generalized tasks.

Block 410 then depicts a later moment in time, when the same user or another user of the LLM service requests that the LLM agent performs a new task for them. Continuing with the example introduced above, the new task may again refer to requesting that the LLM agent sort a spreadsheet by product types that were sold, compute the total sales by respective product types, and subsequently plot the sales, but with regard to a different spreadsheet than before, or wherein the spreadsheet now includes sales from both May and June as opposed to the previous spreadsheet that included sales from just May, etc. The LLM agent is then configured to first perform “recall” using data samples that have already been stored into long-term memory in order to determine if any of those data samples are relevant to performance of this current task. For example, LLM agent may search through data samples that have been labeled as corresponding to this exact user to determine if it has been recorded that the particular user has a first operating system or a second operating system, or if a previous user requested Python or Julia for computing the total sales and plotting the sales, or whether any data samples have been previously stored and labeled as corresponding to the domain knowledge category of product sales for the company.

As introduced above, data samples are stored in a vector form, and thus “recall” refers firstly to the LLM agent establishing an intended deliverable within the request by the user. The LLM agent then prompts a vector search on the long-term memory database, wherein a top K number of results that are deemed as related are applied when attempting to now complete the new task.

In block 412, the LLM agent then applies the knowledge within the data samples it has retrieved from long-term memory when performing the current task.

The process illustrated in FIG. 4 may be repeated any number of times and across an extended period of time, such that the LLM service becomes more efficient in performing tasks for users over time. By configuring reflections agents to store relevant and useful information from communications with users and by configuring LLM agents to “recall” that information when performing the next task, the LLM service develops and maintains a long-term memory for the LLM without having to re-train the model and without updating weights or internal parameters of the model.

The following descriptions pertaining to sub-processes 500, 600, 700, and 800 of performing the reflections protocol by the reflections agent may occur in parallel with one another, sequentially with respect to one another, or by any other combination that ensures that the pre-defined questions that have been supplied via prompt engineering are self-reflected by the reflections agent with regard to domain knowledge categories, user preferences, successful completions of tasks, and failures to complete tasks.

FIG. 5 is a flow diagram that illustrates a first sub-process of performing the reflections protocol introduced in FIG. 4 pertaining to domain knowledge categories, according to some embodiments.

In block 502, the communications log is analyzed to determine if any of the messages sent by the user correspond to a given domain knowledge category. In some embodiments, domain knowledge categories may span multiple dimensions, such as skills in the professional domain, facts about the company using the LLM service, and previous experience. Domain knowledge may also correspond to a new fact (e.g., an updated corporate address for the company after the company has moved locations), a new method of completing a task (e.g., first take the spreadsheet with individualized sales, then sum them together, then plot them), or a new concept (e.g., procedures for year-end reviews of employees).

Following the self-reflection structure introduced above, and continuing with the above example, the reflections agent may answer the following pre-defined questions: “Does this communications log ask the LLM agent to assist with a task?” “Yes, the task is computing monthly sales by product type and plotting the results.” “Does this message contain any domain knowledge?” “Yes.” “What is the domain knowledge about?” “The domain knowledge pertains to tasks completed for the sales department, and to methods for plotting monthly sales reports.”

In block 504, the reflections agent then generates text-based data samples from the communications that correspond to the responses to the pre-defined questions. For example, since the reflections agent determined that the particular task related to methods for plotting monthly sales reports, the corresponding text-based data sample may include information such as the phrasing with which the user requested the plotting and the resulting plots that the LLM agent generated when performing the task.

When generating the data samples that correspond to the confirmed domain knowledge category, the reflections agent may first extract high-level concepts from that portion of the communications log, then proceed to extract the concrete context of domain knowledge and condense the knowledge into a limited number of words. The reflections agent may then generalize the task based on the current task and on the extracted domain knowledge.

In block 506, the reflections agent may additionally search the long-term memory database for any data samples that have similar or exact matching labels to “plotting monthly sales reports,” in order to link related tasks together over time within the long-term memory database. In terms of the self-reflection structure, this particular pre-determined question for the reflections agent may resemble something like “Are there any other tasks in which this domain knowledge can be useful?” This then prompts the reflections agent to search out related data samples within the long-term data storage in order to properly label the data sample it is currently generating and allow for connections to be made with previously stored data samples.

In block 508, the generated data samples, labels corresponding to the particular domain knowledge category, and links to other related data samples that have already been stored in long-term memory are provided to the storage service.

FIG. 6 is a flow diagram that illustrates a second sub-process of performing the reflections protocol introduced in FIG. 4 pertaining to user preferences, according to some embodiments.

In block 602, the communications log is analyzed to determine if any of the messages sent by the user corresponds to indications of user preferences. For example, indications of user preferences may include signatures that a particular user uses a Linux or Mac operating system, or indications that a particular user prefers to write and manage programming code written in C++ vs another user that prefers to write and manage programming code written in Python. User preferences may additionally refer to job titles of the users. For example, indications that a given user works in the marketing department of the company may serve as a user preference indication and, when linked to other data samples within the long-term storage database, may prompt the LLM agent to format plots in a certain way or to use colors that correspond to colors within the company's logo when generating plots for the user within the marketing department. As such, there may be overlap between user preferences and domain knowledge in certain circumstances, according to some embodiments.

Following the self-reflection structure introduced above, and continuing with the above example, the reflections agent may answer the following pre-defined questions: “Does this communications log ask the LLM agent to assist with a task?” “Yes, the task is to write a company news brief for user 302 within the marketing department.” “Does this message contain any user preferences?” “Yes.” “What are the user preferences?” “The user preferences pertain to preparing a company news brief about project XYZ and to use Times New Roman font. ”

In block 604, the reflections agent then generates text-based data samples from the communications that correspond to the responses to the pre-defined questions. For example, since the reflections agent determined that the particular task related to preparing a company news brief, the corresponding text-based data sample may include information such as using Times New Roman font when preparing company news briefs.

In block 606, the generated text-based data samples may be labeled with the name of the user, or some other unique identifier pertaining to that user. In terms of the self-reflection structure, this particular pre-determined question for the reflections agent may resemble something like “Are there any other tasks related to this particular user?” This then prompts the reflections agent to search out related data samples within the long-term data storage that pertain to tasks performed for that particular user in order to build out a user profile. The user profile may refer to a logical term in which any data samples that correspond to tasks completed for that given user are labeled as such.

In block 608, the generated data samples and their labels corresponding to the particular user are provided to the storage service so that they may be stored into the long-term memory database.

FIG. 7 is a flow diagram that illustrates a third sub-process of performing the reflections protocol introduced in FIG. 4 pertaining to success of the LLM agent in performing the task, according to some embodiments.

With regard to sub-process 700, and in what follows with regard to sub-process 800, the following example implementation of the reflections protocol is used for ease of discussion herein: A user of the LLM service starts a chat with an LLM agent of the service, provides a spreadsheet with product sales from last month, and requests that the LLM agent “figure out how many products were returned.” In the conversation with the LLM agent that follows, the LLM agent firstly outputs results of products that were returned that had manufacturing defects, products that were returned that were in good condition, and products that were returned but that were sold over two months ago. The user then adds “No, I meant just products that were returned that had manufacturing defects.” The LLM agent then outputs results pertaining to products that were returned that had manufacturing defects, and removes products that were returned but that were in good condition from the results. Subsequently, the user replies “I want the total money lost doing returns, not the number of returns we did.” The LLM agent then sums together the total money using additional information found in the original spreadsheet, and the user subsequently ends the chat with the LLM agent.

Returning now to sub-process 700, block 702 refers to a moment in time in which the communications log is analyzed to determine if any of the messages sent by the user correspond to indications that the LLM agent successfully completed a task. In the example introduced above, the “successful” completion of the task may refer to the third time that the LLM agent outputted results to the user, wherein the results included a sum of money lost due to returns on products that had manufacturing defects. Moreover, an indication of success by the LLM agent in completing the task may be recognized by an explicit communication from the user that the outputted results positively correspond to the requested deliverable of the task. For instance, following the third attempt by the LLM agent to perform the requested task, the user ended the chat with the LLM agent. In other examples of explicit communication to indicate successful completion of the task, the user may write something resembling “Yes, correct. That's all I need,” or something similar.

Following the self-reflection structure introduced above, and continuing with the above example, the reflections agent may answer the following pre-defined questions: “Does this communications log ask the LLM agent to assist with a task?” “Yes, the task is to search through a spreadsheet for products that were returned due to manufacturing defects and sum together the total money lost doing returns on those products.” “Does the LLM agent successfully assist the user in completing the task?” “Yes.” “What are the deliverables?” “The deliverables are the total money doing returns on products with manufacturing defects. ”

In block 704, the reflections agent then generates text-based data samples from the communications that correspond to the responses to the pre-defined questions. In some embodiments, the data samples may resemble “recipes” which are step-by-step guides and specific deliverables, such as the text of an email, or code snippets for data analysis. Such deliverables may then be used as exemplars in subsequent tasks performed by the LLM agent. Continuing with the example introduced above, the “recipe” may not include the first and second attempts by the LLM agent to perform the task, as these did not indicate “successful” completion of the task. Rather, the generated text-based data samples that form the recipe would include the request by the user and the response by the LLM agent that did indicate success, e.g., the third attempt by the LLM agent.

In block 706, the generated text-based data samples may be labeled such that the particular data sample is understood to illustrate a recipe for success. In block 708, the generated data samples and their labels corresponding to the particular user are provided to the storage service so that they may be stored into the long-term memory database.

FIG. 8 is a flow diagram that illustrates a fourth sub-process of performing the reflections protocol introduced in FIG. 4 pertaining to failures of the LLM agent in performing the task, according to some embodiments.

In block 802, the communications log is analyzed to determine if any of the messages sent by the user correspond to indications that the LLM agent failed to complete a task. In the example introduced above, the “failure” to complete the task may refer to both the first and the second times that the LLM agent outputted results to the user, wherein the results included the incorrect list of returns, and then a list or returns instead of a sum of money lost due to those returns. Moreover, an indication of failure by the LLM agent in completing the task may or may not be recognized by an explicit communication from the user that the outputted results negatively correspond to the requested deliverable of the task. For instance, in the above example, the user explicitly wrote “No, I meant just products that were returned that had manufacturing defects” during the conversation with the LLM agent, indicating that the particular outputted results did not provide the user with the requested deliverable. However, other responses by the user, such as “and now the total money lost from those returns please” may still fall under a category of failure by the LLM agent because the outputted results do not resemble a completion of the task.

Following the self-reflection structure introduced above, and continuing with the above example, the reflections agent may answer the following pre-defined questions: “Does this communications log ask the LLM agent to assist with a task?” “Yes, the task is to search through a spreadsheet for products that were returned due to manufacturing defects and sum together the total money lost doing returns on those products.” “Does the LLM agent fail to assist the user in completing the task?” “Yes.” “What are the failures?” The reflections agent may then self-reflect on the failed first and second attempts to provide the correct results to the user, and generate links to the third attempt that did result in success in order to draw conclusions about the improved “recipe” to use instead next time the LLM agent performs a similar task.

In block 804, the reflections agent then generates text-based data samples from the communications that correspond to the responses to the pre-defined questions. In block 806, the generated text-based data samples may be labeled such that the particular data sample is understood to illustrate a recipe for failure that is not to be directly repeated next time that the LLM agent is performing a task. In block 708, the generated data samples and their labels corresponding to the particular user are provided to the storage service so that they may be stored into the long-term memory database.

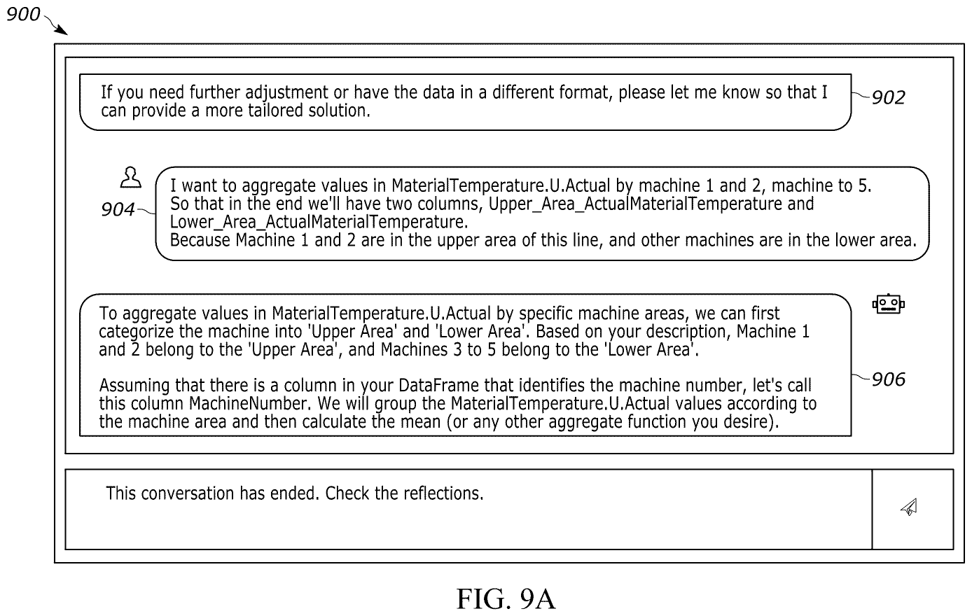

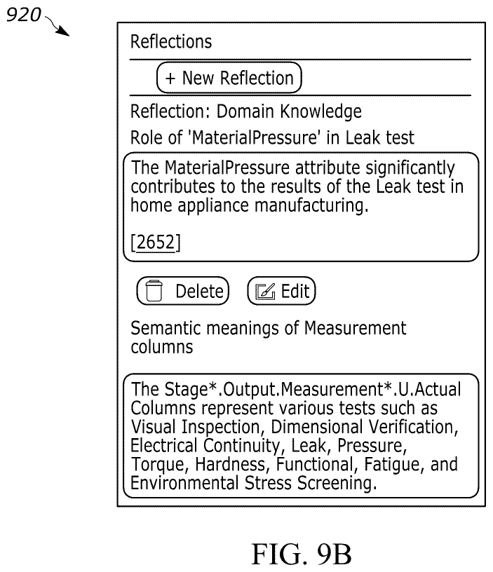

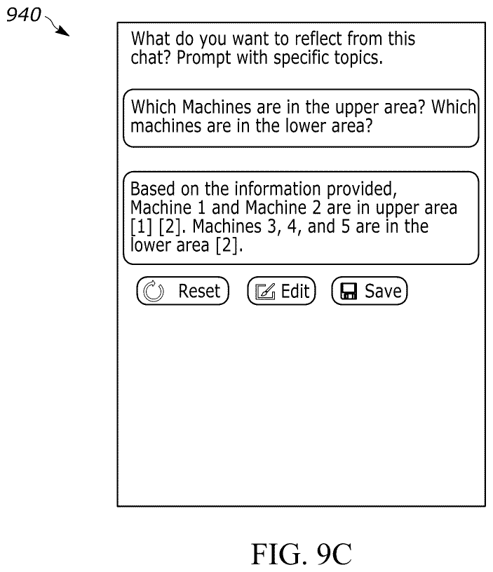

FIG. 9A illustrates an example of a user interface in which a user of the LLM service may chat with an LLM agent of the service in order to perform a task, according to some embodiments.

As illustrated in chat 900, a user is currently chatting with an LLM agent and is already mid-way through performance of the task. Messages 902 and 906 resemble messages sent by the LLM agent and message 904 resembles a message sent by the user. Messages 902, 904, and 906 will be part of a communications log that will be provided to the reflections agent upon completion of the given task.

As illustrated in the particular example shown in FIG. 9A, the user may resemble a data scientist at the company utilizing the LLM service, wherein day-day tasks of the user involve analyzing manufacturing data to uncover patterns and potential problems.

Message 904 includes company-specific and/or internal information, such as data specifications, concept definitions, and the user's programming preferences. During later execution of the reflections protocol by the reflections agent, such information within message 904 will be distilled into data samples pertaining to domain knowledge, to user preferences to be added to the user profile for the user, and to success or not of the LLM agent in the eventual completion of the task.

FIG. 9B illustrates another portion of the user interface in which data samples that were generated during the reflections protocol may be provided for viewing and editing by a user of the LLM service, according to some embodiments.

In some embodiments, after the reflections agent has performed the reflections protocol to extract information and generate data samples corresponding to the relevant information, a user may request to view and/or edit the data samples. For example, if the user reads through the data samples and realizes that their recent request for the LLM agent to perform a task has incorrectly labeled the task as falling under a domain knowledge category of company news briefs instead of investor pitches, the user may prompt, via the user interface, the LLM service to correct this particular labeling prior to storing the data sample into long-term memory storage. In another example, a user may read through their current user profile and realize that the labels for the data sample do not indicate their recent job title change from cite manager to district-wide manager, and similarly prompt the LLM service to correct the data sample.

As illustrated in the portion of the user interface shown in Reflections 920, two different data samples that have a labeling of “domain knowledge” are shown. For example, the internally used parameter called ‘MaterialPressure’ within the company is being stored in long-term memory as being associated with significantly contributing to the results of the Leak test in home appliance manufacturing. In the second data sample shown in FIG. 9B, semantic meanings of Measurement columns are described such that, in the future when an LLM agent is performing a task related to “The Stage*.Output.Measurement*.U.Actual,” particular column references will be recalled by the LLM agent.

FIG. 9C illustrates an example in which the user may add, via the user interface, additional data samples to those that were generated during the reflections protocol, according to some embodiments.

In addition to the various sub-processes 500, 600, 700, and 800 described above, users of the LLM service may additionally add their own “user-defined” reflections to the data samples that are stored into the long-term memory database. For example, if a user is viewing reflections generated about a task that requires the context of the company's organizational chart for efficient completion, then a user may proactively provide the company's organizational chart as an additional data sample that is to be stored into long-term memory for future recall by the LLM agent.

In the portion of the user interface shown in FIG. 9C, block 940 refers to a user detailing an additional reflection that will then be distilled into a data sample. The user prompts the LLM service with “Which machines are in the upper area? Which machines are in the lower area?” The LLM service responds with “Machine 1 and Machine 2 are in the upper area. Machines 3, 4, and 5 are in the lower area.” That additional communications log is then distilled into data samples that are stored into the long-term memory database.

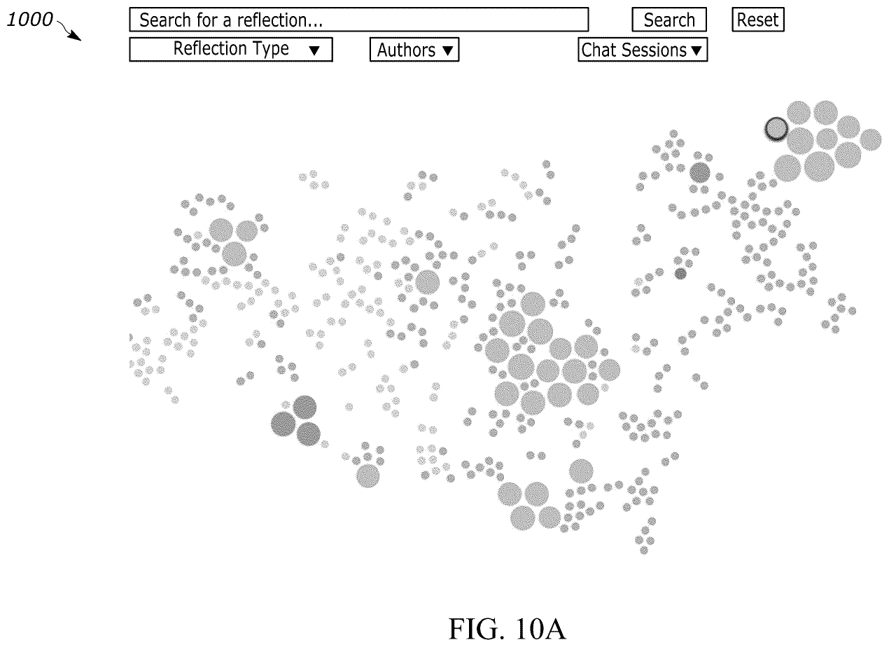

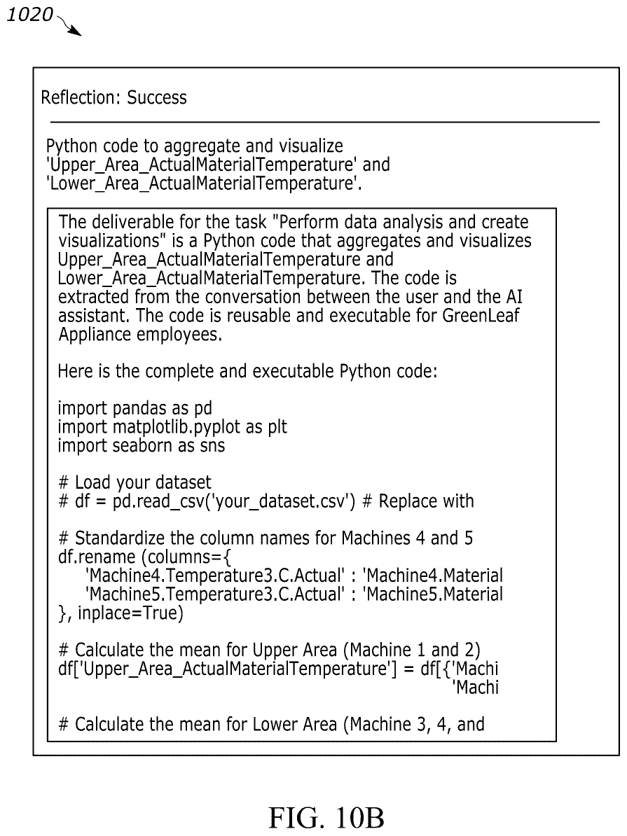

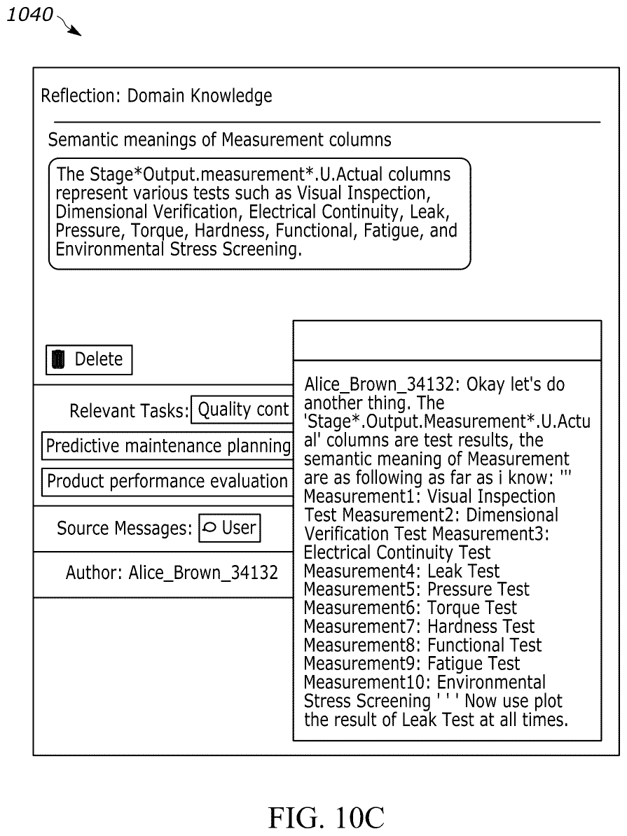

FIG. 10A illustrates another portion of the user interface in which a user of the LLM service may view and search for data samples which have already been stored to the long-term memory database, according to some embodiments.

As introduced above with regard to FIG. 3, users of the LLM service may also perform knowledge searches in order to view data samples that have been stored into long-term memory. For example, if a user is a new employee of the company, they may perform various searches via the user interface in order to learn context for some of their new and upcoming projects. In another example, if a given employee is needing to generate a company news brief for the first time, but they know that other company news briefs have been generated in the past by other employees, they may perform a knowledge search in order to use those company news briefs as templates.

As illustrated in the portion of the user interface 1000 shown in FIG. 10A, there is a search bar for users to search for certain domain knowledge, etc., that has been stored by the LLM service. Furthermore, each bubble on the screen indicates a given data sample, wherein distance between bubbles indicate similarities in vector space.

FIG. 10B illustrates an example of a data sample from long-term memory storage that is being viewed by a user using the user interface, according to some embodiments.

As shown in block 1020, the given data sample is organized as a recipe for successful completion of a task by the LLM agent. The data sample includes the requested deliverable, “Perform data analysis and create visualizations” along with a snippet of code.

FIG. 10C illustrates another example of a data sample from long-term memory storage that is being viewed by a user using the user interface, according to some embodiments.

As additionally indicated in block 1040, a given data sample within the domain knowledge category “semantic meanings of Measurement columns” additionally displays to the user the other data samples that the LLM service has labeled as being related, or relevant, or similar to the given data sample.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A computer-implemented method for managing long-term memory of a Large Language Model (LLM), comprising:
receiving, from a user of an LLM service, a first request for an LLM agent of the LLM service to perform a first task;
performing, by the LLM agent, the first task and outputting results of the first task to the user;
performing, by a reflections agent of the LLM service, a reflections protocol to generate data samples based on analyzing communications between the user and the LLM agent during the performing the first task;
storing the data samples into a long-term memory database of the LLM service;
responsive to receiving a second request for the LLM agent to perform a second task, performing recall using the long-term memory database to determine one or more of the data samples that are relevant to the performance of the second task; and
performing, by the LLM agent, the second task based on the recall of the one or more of the data samples stored in the long-term memory database.

2. The computer-implemented method of claim 1, wherein the performing the reflections protocol comprises:
analyzing the communications to determine which domain knowledge category that the first task corresponds to;
generating text-based data samples from the communications that correspond to the domain knowledge category and to the outputted results of the first task;
searching the long-term memory database for related tasks based on the domain knowledge category; and
providing the text-based data samples and links to the related tasks to be stored into the long-term memory database.

3. The computer-implemented method of claim 2, wherein domain knowledge categories comprise at least company-specific procedures and professional, workplace skillsets.

4. The computer-implemented method of claim 1, wherein the performing the reflections protocol comprises:
analyzing the communications to determine indications of user preferences of the user throughout the communications;
generating text-based data samples from the communications that correspond to the user preferences of the user;
labeling the text-based data samples as corresponding to the user; and
providing the text-based data samples and the labels to be stored into the long-term memory database.

5. The computer-implemented method of claim 4, wherein the indications of user preferences comprise at least indications of computer operating systems for specific users and preferred programming languages for specific users.

6. The computer-implemented method of claim 1, wherein the performing the reflections protocol comprises:
analyzing the communications to determine an indication of successful completion by the LLM agent of the first task;
generating text-based data samples from the communications that correspond to a requested deliverable within the first task by the user and to the outputted results of the first task by the LLM agent;
labeling the text-based data samples as successful completions by the LLM agent; and
providing the text-based data samples and the labels to be stored into the long-term memory database.

7. The computer-implemented method of claim 6, wherein the indication of successful completion comprises an explicit communication from the user that the outputted results positively correspond to the requested deliverable of the first task.

8. The computer-implemented method of claim 1, wherein the performing the reflections protocol comprises:
analyzing the communications to determine an indication of failure by the LLM agent to perform the first task;
generating text-based data samples from the communications that correspond to a requested deliverable within the first task by the user and to failed results of the first task by the LLM agent;
labeling the text-based data samples as failures by the LLM agent; and
providing the text-based data samples and the labels to be stored into the long-term memory database.

9. The computer-implemented method of claim 8, wherein the indication of failure comprises an explicit communication from the user that the outputted results do not correspond to the requested deliverable of the first task.

10. The computer-implemented method of claim 1, further comprising:
providing, by the reflections agent, the data samples that were generated during performance of the reflections protocol to the user via a user interface of the LLM service;
receiving an indication from the user to edit one of the data samples or to add an additional data sample; and
storing the edited one of the data samples or the additional data sample into the long-term memory database of the LLM service.

11. A computer-implemented method for managing long-term memory of a Large Language Model (LLM), comprising:
receiving, by a reflections agent of an LLM service, a log of communications between an LLM agent and a user of the LLM service, wherein the log comprises a request from the user to perform a task and a response by the LLM agent to perform the task;
performing, by the reflections agent, a reflections protocol to generate data samples based on analyzing the request and the response within the log of communications, wherein the reflections protocol extracts the data samples based on domain knowledge categories, user preferences, and on indications of success or failure of the LLM agent to perform the task; and
storing the data samples into a long-term memory database of the LLM service for future recall when the LLM agent performs other tasks for other users of the LLM service.

12. The computer-implemented method of claim 11, further comprising generating the reflections protocol for the LLM service, wherein self-reflection questions that are to be executed by the reflections agent are generated using prompt engineering methods.

13. The computer-implemented method of claim 11, further comprising:
receiving another request for the LLM agent to perform another task;
performing recall using the long-term memory database to determine one or more of the data samples that are relevant to the performance of the other task; and
performing, by the LLM agent, the other task based on the recall of the one or more of the data samples stored in the long-term memory database.

14. A system, comprising:
a database configured to store a plurality of data samples that are made accessible to a Large Language Model (LLM) agent and a reflections agent of an LLM service; and
computing devices configured to implement the LLM service, wherein the LLM service is configured to:
receive, from a user of the LLM service, a first request for the LLM agent to perform a first task;
perform, by the LLM agent, the first task and output results of the first task to the user;
execute, by the reflections agent, a reflections protocol to generate additional data samples based on an analysis of communications between the user and the LLM agent during the performance of the first task;
provide the additional data samples for long-term memory storage within the database;
responsive to reception of a second request for the LLM agent to perform a second task, access the long-term memory storage within the database to determine one or more of the plurality of data samples that are relevant to the performance of the second task; and
perform, by the LLM agent, the second task based on the one or more of the data samples.

15. The system of claim 14, wherein the computing devices are further configured to:
implement a user interface of the LLM service;
responsive to the execution of the reflections protocol, provide the additional data samples to the user via the user interface;
receive an indication from the user to edit one of the additional data samples or to add another data sample; and
provide the edited one of the additional data samples or the other data sample for long-term memory storage within the database.

16. The system of claim 15, wherein:
the database is further configured to store user permissions corresponding to accessing the plurality of data samples; and
the computing devices are further configured to:
responsive to reception of another request from the user to access one or more of the plurality of data samples, confirm that the user has permission based on the user permissions stored in the database; and
provide the one or more of the plurality of data samples to the user via the user interface.

17. The system of claim 14, wherein, to execute the reflections protocol, the computing devices are further configured to:
analyze the communications to determine which domain knowledge category that the first task corresponds to;
generate text-based data samples from the communications that correspond to the domain knowledge category and to the outputted results of the first task;
search the long-term memory storage within the database for related tasks based on the domain knowledge category; and
provide the text-based data samples and links to the related tasks to be stored into the long-term memory storage within the database.

18. The system of claim 14, wherein, to execute the reflections protocol, the computing devices are further configured to:
analyze the communications to determine indications of user preferences of the user throughout the communications;
generate text-based data samples from the communications that correspond to the user preferences of the user;
label the text-based data samples as corresponding to the user; and
provide the text-based data samples and the labels to be stored into the long-term memory storage within the database.

19. The system of claim 14, wherein, to execute the reflections protocol, the computing devices are further configured to:
analyze the communications to determine an indication of successful completion by the LLM agent of the first task;
generate text-based data samples from the communications that correspond to a requested deliverable within the first task by the user and to the outputted results of the first task by the LLM agent;
label the text-based data samples as successful completions by the LLM agent; and
provide the text-based data samples and the labels to be stored into the long-term memory storage within the database.

20. The system of claim 14, wherein, to execute the reflections protocol, the computing devices are further configured to:
analyze the communications to determine an indication of failure by the LLM agent to perform the first task;
generate text-based data samples from the communications that correspond to a requested deliverable within the first task by the user and to failed results of the first task by the LLM agent;
label the text-based data samples as failures by the LLM agent; and
provide the text-based data samples and the labels to be stored into the long-term memory storage within the database.
